(19) United States
(12) Patent Application Publication
(10) Pub. No.: US 2008/0239988 A1
(43) Pub. Date: Oct. 2, 2008

(54) Method and System For Network Infrastructure Offload Traffic Filtering

(76) Inventors: Henry Ptasinski, San Francisco, CA (US); Raymond Hayes, Los Gatos, CA (US)

Correspondence Address: MCANDREWS HELD & MALLOY, LTD, 500 WEST MADISON STREET, SUITE 3400, CHICAGO, IL, 60661, US

(21) Appl. No.: 12/056,817

(22) Filed: Mar. 27, 2008

Related U.S. Application Data
(60) Provisional application No. 60/908,789, filed on Mar. 29, 2007.

(51) Int. Cl. H04L 12/28

(52) U.S. Cl. 370/254

(57) ABSTRACT

Aspects of a method and system for network infrastructure offload traffic filtering are disclosed and may include a networked device, or station, which may communicate one or more filters to an infrastructure networking device. The infrastructure networking device may utilize the filters to implement filtering rules upon traffic received by the infrastructure networking device on behalf of the station. Based on the filters, the infrastructure networking device may determine whether to transmit received traffic to the station via a network, or whether to discard received traffic. The infrastructure networking device may perform traffic shaping based on the filters.

### CROSS-REFERENCE TO RELATED APPLICATIONS/INCORPORATION BY REFERENCE

This application makes reference to, claims priority to, and claims the benefit of U.S. Provisional Application Ser. No. 60/908,789 filed on Mar. 29, 2007, which is hereby incorporated herein by reference in its entirety.

### FIELD OF THE INVENTION

Certain embodiments of the invention relate to communication networks. More specifically, certain embodiments of the invention relate to a method and system for network infrastructure offload traffic filtering.

### BACKGROUND OF THE INVENTION

Networked devices typically comprise at least two components: a network interface controller (NIC) and a central processing unit (CPU, or “host”). The networked device may be connected to other networked devices via a network, such as a local area network (LAN), metropolitan area network (MAN) or wide area network (WAN) such as the Internet. Networks may utilize wired networking technologies and/or wireless networking technologies. IEEE 802 describes communication architectures, which enable networked devices to communicate via a LAN or MAN.

Traffic may refer to frames, packets, or other protocol data units (PDUs), which may be utilized to communicate data between networked devices via a network. A given destination networked device may receive traffic from any remote networked device, which is able to communicate with the networked device via a network. However, given the possibility that the received traffic may comprise undesired information (such as spam) and/or data, which, if received, may corrupt the operation of the destination networked device (such as viruses), the destination networked device may utilize software, such as firewall software, which enables the destination networked device to filter received traffic. In addition, unwanted traffic adds to the processing load on the system, which may impact system performance. For example, the firewall software may implement rules, which enable the destination networked device to determine when to discard received traffic. Rules of this type may be referred to as “negative filters”. Negative filters can be used to discard traffic from specified sources. Alternatively, the firewall software may implement rules, which enable the destination networked device to determine when to accept, or not discard, received traffic. Rules of this type may be referred to as “positive” filters. Positive filters can be used to allow traffic from specified sources.

The characteristics, or profile, of the traffic received at the destination networked device may be intermittent, or continuous. An example of continuous traffic is streaming data, which may be utilized to communicate video and/or audio to the destination networked device. In instances when the destination networked device is receiving continuous traffic, the destination networked device may implement rules, which control the rate at which received traffic will be accepted. Rules of this type may be referred to as “traffic shaping”. Traffic shaping rules may enable the destination networked device to store the received traffic and determine time instants at which the received traffic is to be retrieved from storage and processed. Traffic shaping rules may enable the destination networked device to discard stored traffic or to discard the received traffic without storing the traffic.

IEEE 802.11 describes a communication architecture, which may enable networked devices to communicate via wireless local area networks (WLANs). One of the building blocks for the WLAN is the basic service set (BSS). A BSS may comprise a plurality of networked devices, or stations (STA), which may communicate wirelessly via one or more RF channels within a coverage area. The span of a coverage area may be determined based on the distance over which a source STA may transmit data via an RF channel, which may be received by a destination STA.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and system for network infrastructure offload traffic filtering, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary system for wireless data communication, which may be utilized in connection with an embodiment of the invention.

FIG. 2 is a block diagram of an exemplary system for wired network data communication, which may be utilized in connection with an embodiment of the invention. FIG. 2 shows an exemplary LAN.

FIG. 3 is a flow chart, which illustrates exemplary steps for infrastructure networking device operation in a network infrastructure offload traffic filtering system, in accordance with an embodiment of the invention.

FIG. 4 is a flow chart, which illustrates exemplary steps for networked device operation in a network infrastructure offload traffic filtering system, in accordance with an embodiment of the invention.

FIG. 5 is a flow chart, which illustrates exemplary steps for filtering of multi-frame sequences, in accordance with an embodiment of the invention.

### DETAILED DESCRIPTION OF THE INVENTION

Certain embodiments of the invention may be found in a method and system for network infrastructure offload traffic filtering. Various embodiments of the invention comprise a method and system in which a networked device, or station, may communicate one or more filters to an infrastructure networking device. The infrastructure networking device may utilize the filters to implement filtering rules upon traffic received by the infrastructure networking device on behalf of the station. Based on the filters, the infrastructure networking device may determine whether to transmit received traffic to the station via a network, or whether to discard received traffic. Discarded traffic may not be transmitted via the network to the station by the infrastructure networking device.

In an exemplary embodiment of the invention, the filters may be utilized to implement positive and/or negative filters. In an exemplary embodiment of the invention, the filters may be utilized to implement traffic shaping. Various embodiments of the invention may not be limited to the exemplary embodiments disclosed herein and may be practiced in other embodiments in which an infrastructure networking device performs filtering operations on behalf of a station, which receives traffic via a network from the infrastructure networking device.

Various embodiments of the invention may be practiced when the infrastructure networking device and the station communicate via wireless networking technologies, such as WLANs. Various embodiments of the invention may be practiced when the infrastructure networking device and the station communicate via wired networking technologies, such as wired LANs. Various embodiments of the invention may be practiced when the infrastructure networking device and the station communicate via any combination of wired networking technologies and/or wireless networking technologies. In general, an infrastructure networking device may refer to a device, which enables networked devices to communicate via a network. An AP is an exemplary infrastructure networking device, which may be utilized to enable networked devices (for example, STAs) to communicate via a WLAN. An Ethernet switching device is an exemplary infrastructure networking device, which may be utilized to enable networked devices to communicate via a LAN.

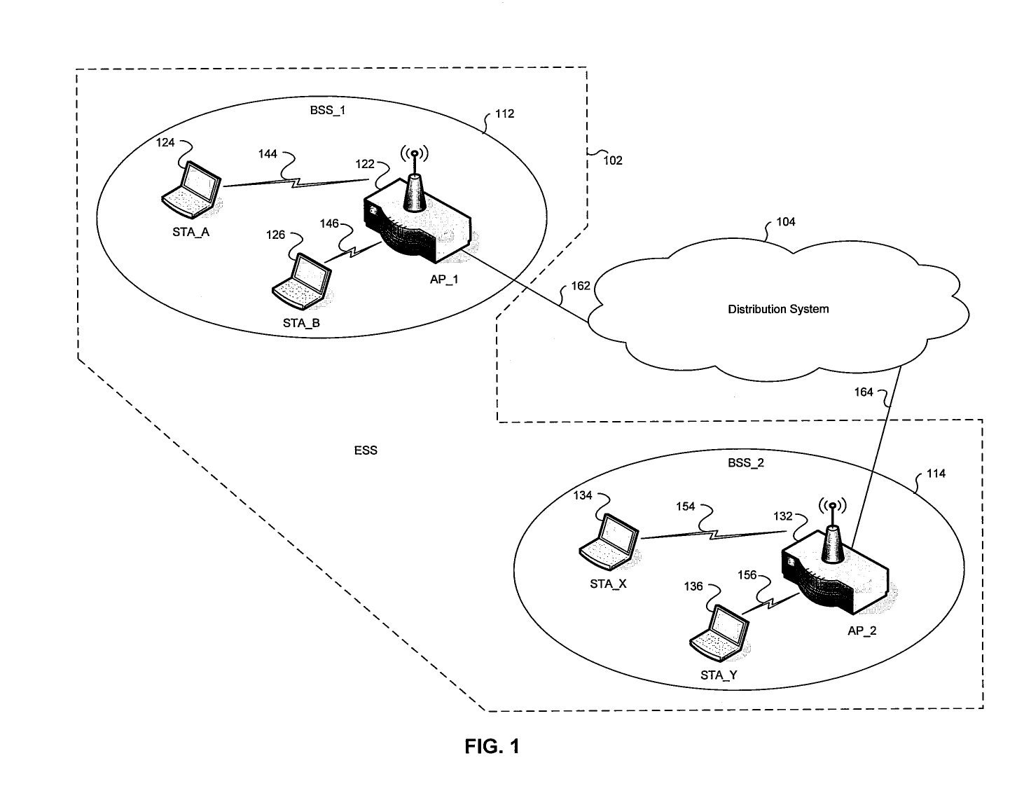

FIG. 1 is a block diagram of an exemplary system for wireless data communication, which may be utilized in connection with an embodiment of the invention. FIG. 1 shows an exemplary WLAN. Referring to FIG. 1, there is shown an ESS 102 and a distribution system (DS) 104. The ESS 102 comprises a BSS_1 112 and a BSS_2 114. The BSS_1 112 comprises an AP_1 122, a WLAN station STA_A 124 and a STA_B 126. The BSS_2 114 comprises an AP_2 132, a STA_X 134 and a STA_Y 136. Each STA 124, 126, 134 and 136 may comprise a NIC and a host.

The DS 104 may provide an infrastructure, which may be utilized to enable any of the STAs within the BSS_1 112 to communicate with any of the STAs within BSS_2 114, or vice versa. The DS 104 may utilize wireless communication (for example, via one or more RF channels), wired communication (for example, via copper or optical fiber cabling) or a combination thereof.

Within BSS_1 112, the AP_1 122 may communicate with the STA_A 124 via one or more RF channels 144. The AP_1 122 may communicate with the STA_B 126 via one or more RF channels 146. The STA_A 124 may communicate with the STA_B 126 by sending a frame to the AP_1 122. Upon receipt of the frame, the AP_1 122 may determine that the destination for the frame is the STA_B 126. The AP_1 122 may then send the frame to the STA_B 126. Within the BSS_2 114, the AP_2 132 may communicate with the STA_X 134 via one or more RF channels 154. The AP_2 132 may communicate with the STA_Y 136 via one or more RF channels 156. The STA_X 134 and the STA_Y 136 may communicate in a manner, which is substantially similar to that described for the STA_A 124 and the STA_B 126.

The AP_1 122 may communicate reachability information to the AP_2 132 via the DS 104. The reachability information may enable the AP_2 132 to determine a route by which frames may be delivered to the STA_A 124 and/or the STA_B 126. For example, if the STA_X 134 sends a frame to the AP_2 132 for which the destination address identifies the STA_A 124, the AP_2 132 may send the frame to the AP_1 122 via the DS 104. The interface 164 over which the AP_2 132 sends the frame to the DS 104 may utilize a wired interface (such as copper or optical fiber cabling) and/or wireless interface (such as one or more RF channels). Similarly, the interface 162 over which the AP_1 122 receives the frame from the DS 104 may utilize a wired interface and/or wireless interface.

In various embodiments of the invention, a STA 122 may communicate one or more filter descriptors, or filters, to the AP 124. The filter descriptors may enable the AP 124 to perform traffic filtering operations on traffic received at the AP on behalf of the STA 122. In an exemplary embodiment of the invention in which the filter descriptors comprise negative filters, the AP 124 may utilize the filter descriptors to determine when to discard traffic, which is destined for the STA 122. In instances when traffic is discarded under the negative filter rules, the AP 124 may not transmit traffic to the STA 122. In instances when traffic is not discarded under the negative filter rules, the AP 124 may transmit traffic to the STA 122.

In an exemplary embodiment of the invention in which the filter descriptors comprise positive filters, the AP 124 may utilize the filter descriptors to determine when to transmit traffic to the STA 122, which is destined for the STA 122. In instances when the traffic is to be transmitted under the positive filter rules, the AP may transmit traffic to the STA 122. In instances when traffic is discarded under the positive filter rules, the AP 124 may not transmit traffic to the STA 122.

In an exemplary embodiment of the invention in which the filter descriptors comprise traffic shaping rules, the AP 124 may utilize the filter descriptors to determine when to discard traffic, which is destined for the STA 122. In instances when the traffic is not discarded upon receipt, the AP 124 may either immediately transmit traffic to the STA 122 and/or store traffic destined for the STA 122. In instances when traffic is stored on behalf of the STA 122, the AP 124 may determine a later time instant at which to transmit stored traffic to the STA 122. The AP 124 may provide a limited quantity of buffer capacity to enable storage of received traffic. Based on the buffer capacity limit, the AP 124 may subsequently discard traffic stored on behalf of the STA 122. The discarded traffic may not be transmitted to the STA 122. In an exemplary embodiment of the invention, the AP 124 may discard earliest received traffic to enable storage of more recently received traffic.

In various embodiments of the invention, a STA 122, the filter descriptors may describe the characteristics of filters, which are to be utilized by the AP 124 when receiving frames on behalf of the STA 122. An exemplary filter characteristic is a filtering pattern, such as a bit pattern, which may be utilized by the AP 124 to locate a matching bit pattern in a received frame. The AP 124 may utilize the filters to perform pattern matching on received frames. In an exemplary embodiment of the invention, the AP 124 may detect a match between a received frame and a given filter when a bit pattern contained within a selected field within the received frame (where the selected field may be determined based on the filter descriptor) matches a pattern defined in the filter descriptor. In an exemplary embodiment of the invention in which the filter descriptor(s) implement a positive filter, the AP 124 may transmit a received frame when a pattern match is detected. In an exemplary embodiment of the invention in which the filter descriptor(s) implement a negative filter, the AP 124 may discard a received frame when a pattern match is detected. In an exemplary embodiment of the invention in which the filter descriptor(s) implement traffic shaping rules (which may also be referred to as a traffic shaping filter), the AP 124 may perform traffic shaping when a pattern match is detected. The filter descriptor(s) may define the traffic shaping characteristics, which enable the AP 124 to determine how to schedule delivery of stored frames, when to discard stored frames, etc.

In an exemplary embodiment of the invention, the STA_A 124 may communicate positive filter rules, which enable the AP_1 122 to transmit traffic to STA_A 124 when the source of the traffic is the STA_B 126. The STA_B 126 may transmit one or more frames for delivery to the STA_A 124. The STA_B 126 may transmit the frames to the AP_1 122. The AP_1 122 may determine the source address of the received frames refers to the STA_B 126 and the destination address refers to the STA_A 124. Upon determining that the destination address refers to the STA_A 124, the AP_1 122 may utilize the positive filter rules for the STA_A 124 to determine whether to transmit the frame received from the STA_B 126. Upon determining that the positive filter rules enable transmission of traffic to the STA_A 124 when the source address for the received frame(s) refers to the STA_B 126, the AP_1 122 may transmit the frame(s) to the STA_A 124.

When the STA_X 134 transmits frame(s) to the STA_A 124, the STA_X 134 may transmit the frame(s) to the AP_2 132. The AP_2 132 may transmit the frame(s) to the AP_1 122 via the DS 104. The AP_1 122 may determine that the source of the frame(s) refers the STA_X 134 and the destination address refers to the STA_A 124. Upon determining that the destination address refers to the STA_A 124, the AP_1 122 may utilize the positive filter rules for the STA_A 124 to determine whether to transmit the frame received from the STA_X 134. Upon determining that the positive filter rules do not enable transmission of traffic to the STA_A 124 when the source address for the received frame(s) does not refer to the STA_B 126, the AP_1 122 may discard the received frame(s). Frames may also originate from devices on a wired network that is connected to the wireless network via a portal. Similarly, a wireless STA may send frames to a wired terminal. An infrastructure device within the network, such as a switch, may perform filtering on traffic between the wireless STA and the wired terminal.

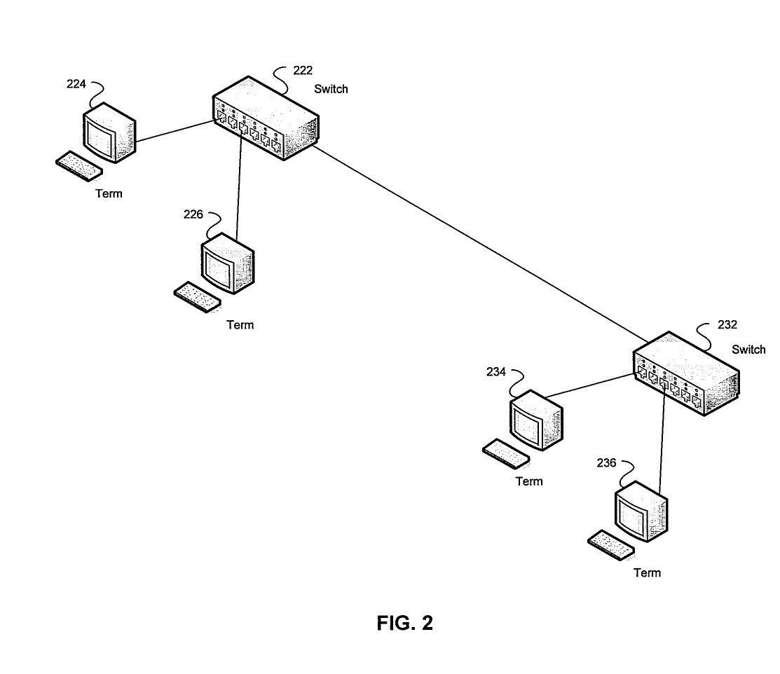

FIG. 2 is a block diagram of an exemplary system for wired network data communication, which may be utilized in connection with an embodiment of the invention. FIG. 2 shows an exemplary LAN. Referring to FIG. 2, there is shown a plurality of terminal devices 224, 226, 234 and 236 and a plurality of switching devices (Switch) 222 and 232. Terminal device 224 may be communicatively coupled to the switch 222 via a wired medium. The terminal device 226 may be communicatively coupled to the switch 222 via a wired medium. The terminal device 234 may be communicatively coupled to the switch 232 via a wired medium. The terminal device 236 may be communicatively coupled to switch 232 via a wired medium. The switch 222 may be communicatively coupled to switch 232 via a wired medium. The terminal device 224, 226, 234 and 236 represent exemplary networked devices. The switches 222 and 232 represent exemplary infrastructure networking devices, which enable communication between the terminal devices 224, 226, 234 and 236. In an exemplary IEEE 802 LAN, the switches 222 and 232 may represent Ethernet switching devices.

A given terminal device, such as the terminal device 224 may advertise reachability information, such as a station address to the switch 222. The switch 222 may communicate reachability information for the terminal device 224 to the terminal device 226 and to the switch 232. The switch 232 may communicate the reachability information for the terminal device 224 to the terminal device 234 and to terminal device 236. By similar advertisement of reachability information from the terminal device 226, 234 and 236, communication among the terminal devices may be enabled via the switches 222 and 232.

In an exemplary embodiment of the invention, the terminal device 224 may communicate negative filter rules, which enable the switch 222 to transmit traffic to the terminal device 224 when the source of the traffic is not the terminal device 226. The terminal device 226 may transmit one or more frames for delivery to the terminal device 224. The frames transmitted by the terminal 226 may be received at the switch 222. The switch 222 may determine that the source address of the received frames refers to the terminal device 226 and the destination address refers to the terminal device 224. Upon determining that the destination address refers to the terminal device 224, the switch 222 may utilize the negative filter rules for the terminal device 224 to determine whether to transmit the frame(s) received from the terminal device 226. Upon determining that the negative filter rules disable, or block, transmission of traffic to the terminal device 224 when the source address for the received frame(s) refers to the terminal device 226, the terminal device 222 may discard the received frame(s).

When the terminal device 234 transmits frame(s) to the terminal device 224, the frames transmitted by the terminal device 234 may be received at the switch 232. The switch 232 may transmit the frame(s) to switch 222. The switch 222 may determine that the source of the frame(s) refers to the terminal device 234 and the destination address refers to the terminal device 224. Upon determining that the destination address refers to the terminal device 224, the switch 222 may utilize the negative filter rules for the terminal device 224 to determine whether to transmit the frame received from the terminal device 234. Upon determining that the negative filter rules enable transmission of traffic to the terminal device 224 when the source address for the received frame(s) does not refer to the terminal device 226, the switch 222 may transmit the frame(s) to the terminal device 224. Filters may be positive or negative, may include various pattern match rules or may incorporate stateful rules that are applied across multiple packets.

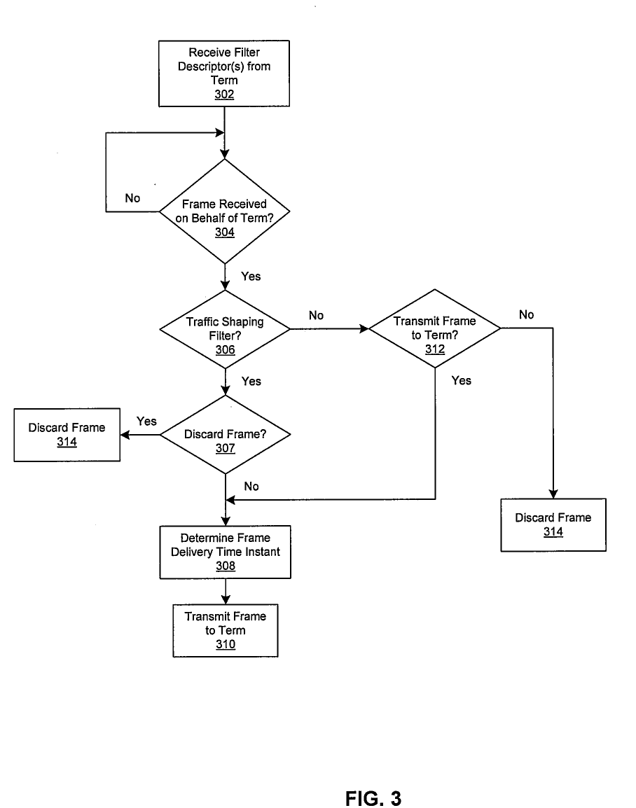

FIG. 3 is a flow chart, which illustrates exemplary steps for infrastructure networking device operation in a network infrastructure offload traffic filtering system, in accordance with an embodiment of the invention. Referring to FIG. 3, in step 302, an AP may receive one or more filter descriptors from a terminal device (Term). In step 304, the infrastructure device may determine whether a frame has been received on behalf of the terminal device. In instances when a frame is received at the infrastructure device on behalf of the terminal device, in step 306, the infrastructure device may determine whether the filter descriptor(s) implement traffic shaping rules. In instances when the filter descriptors received at step 302 implement traffic shaping rules, in step 307, the infrastructure device may determine whether to discard the frame. In instance in which the frame is not discarded, in step 308, the infrastructure device may determine a time instant for delivery of the frame. In step 310, the infrastructure device may transmit the frame to the terminal device.

In instances when the filter descriptor(s) do not implement traffic shaping rules in step 306, in step 312, the infrastructure device may determine whether the filter descriptor(s) enable the infrastructure device to transmit the received frame to the terminal device. In instances when the filter descriptor(s) enable the infrastructure device to transmit the frame, step 310 may follow. In instances when the filter descriptor(s) do not enable the infrastructure device to transmit the frame, in step 314, the frame may be discarded by the infrastructure device without being transmitted to the terminal device.

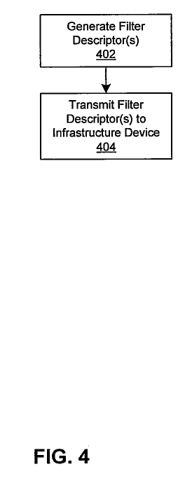

FIG. 4 is a flow chart, which illustrates exemplary steps for networked device operation in a network infrastructure offload traffic filtering system, in accordance with an embodiment of the invention. Referring to FIG. 4, in step 402, a terminal device may generate one or more filter descriptors. In step 404, the terminal device may transmit the filter descriptors to an infrastructure networking device, such as an infrastructure device.

In various embodiments of the invention, the filters may be utilized to implement a variety of functions. In an exemplary embodiment of the invention, the filters may enable pattern matches when a received frame comprises a specific network address or a specific set of network addresses. In an exemplary embodiment of the invention, the filters may enable pattern matches when a received frame comprises a specific port identifier, such as may enable determination of the whether the frame comprises data generated by a world wide web related application, or an electronic mail (email) related application, or by a file transfer protocol (FTP) application, &c. In an exemplary embodiment of the invention, the filters may enable pattern matches when a received frame comprises a specific process identifier or set of process identifiers, such as may enable determination of whether the frame comprises data generated by a specific application instance (for example, a specific instance of a database application, which is executing on a remote STA as distinguished from other instances of the database application that may be executing on the same remote STA).

In various embodiments of the invention, the STA 122 may communicate filters and/or information associated with the filters, which enables the AP 124 to perform authentication operations on received frames, such as verification of authentication keys, passwords, passphrases and/or authentication certificates.

In various embodiments of the invention, the STA 122 may communicate filters and/or information associated with the filters, which enables the AP 124 to determine a pattern match based on a sequence of received frames. For example, the AP 124 may utilize a first pattern in a pattern sequence for pattern matching operations. When a pattern match is detected, the AP 124 may infer that the received frame is the first frame in a multi-frame sequence. The AP 124 may then utilize a second pattern in the pattern sequence for pattern matching operations on the next frame received on behalf of the STA 122. If a pattern match is not detected for the second received frame, or for any subsequent received frame, the AP 124 may determine that a pattern match has not been detected between the pattern sequence and the sequence of received frames. In an exemplary embodiment of the invention, the pattern matching against received multi-frame sequences may enable the AP 124 to monitor the connection state for communications between the STA 122, on which behalf the AP 124 is filtering the frames, and the remote STA 122, which may be the source of the received frames.

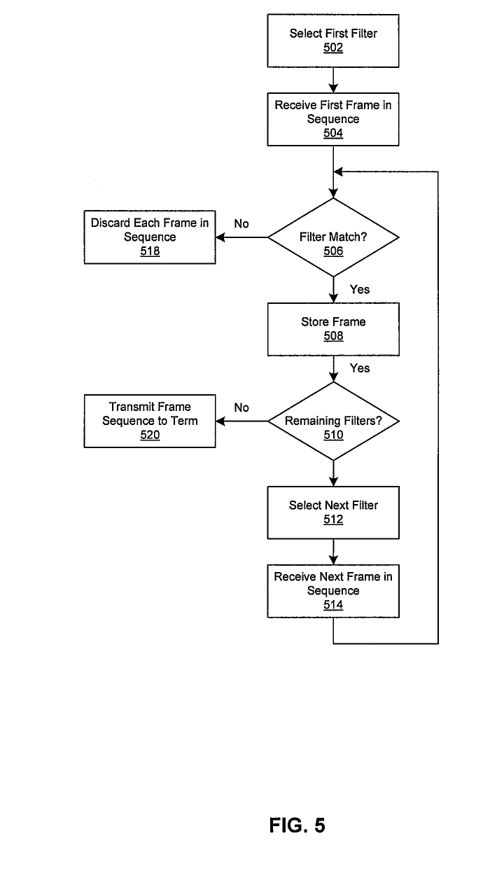

FIG. 5 is a flow chart, which illustrates exemplary steps for filtering of multi-frame sequences, in accordance with an embodiment of the invention. Filtering of multi-frame sequences is also referred to as “stateful” filtering. Referring to FIG. 5, in step 502 a first filter may be selected. The first filter may be utilized for filtering of a first received frame in a multi-frame sequence. In step 504, the first frame in the sequence may be received at an infrastructure device. Step 506 may determine whether there is a filter match. In instances when there is not a filter match, in step 518, each frame in the multi-frame sequence may be discarded.

In instances when there is a filter match in step 506, in step 508, the frame may be temporarily stored pending receipt of the remaining frames in the multi-frame sequence. Step 510 may determine whether there are additional filters to be utilized for filtering of the multi-frame sequence. In instances when there are no more filters, in step 520, the frame sequence may be transmitted to the terminal device.

In instances when there are additional filters, in step 512, the next filter may be selected. The next filter may be the same as one or more preceding filters or the next filter may be different from any of the preceding filters. The next filter may be utilized for filtering of the next received frame in the multi-frame sequence. In step 514, the next frame in the sequence may be received at the infrastructure device. Step 506 may follow step 514.

Various embodiments of the invention may not be limited to Ethernet or data link layer communication technologies. For example, various embodiments of the invention may be practiced in connection with network layer communication technologies, such as the Internet Protocol (IP). Various embodiments of the invention may be practiced in connection with transport layer communication technologies, such as the Transmission Control Protocol (TCP) or the User Datagram Protocol (UDP). Consequently, various embodiments of the invention may be limited to instances when the infrastructure network device comprises an Ethernet switching device. Various embodiments of the invention may be practiced in instances when the infrastructure networking device comprises a router device, for example.

Various embodiments of the invention may be practiced in instances when traffic comprises any of a variety of protocol data units (PDUs). Exemplary PDUs may comprise, but are not limited to, frames, packets or other entities, which are utilized to enable the communication of data via a network.

Another embodiment of the invention may provide a machine and/or computer readable medium, having stored thereon, a computer program having at least one code section executable by a machine and/or computer, thereby causing the machine and/or computer to perform the steps as described herein for network infrastructure offload traffic filtering.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system for communicating data, the system comprising:
one or more circuits that enable reception, via a network, of one or more filtering descriptions at an infrastructure networking device from a destination station device, wherein said infrastructure networking device enables said destination station device to communicate with said destination station and other station devices via said network;
said one or more circuits enable reception, at said infrastructure networking device, of one or more protocol data units destined for said destination station device; and
said one or more circuits enable processing of said received one or more protocol data units at said infrastructure networking device based on said one or more filtering descriptions.

2. The system according to claim 1, wherein said one or more circuits enable generation of one or more filtering patterns based on said one or more filtering descriptions.

3. The system according to claim 2, wherein said one or more circuits enable determination of whether to perform one of the following actions: transmit said processed said received one or more protocol data units, and discard said processed said received one or more protocol data units; based on said one or more filtering patterns.

4. The system according to claim 3, wherein said one or more circuits enable transmission of said processed said received one or more protocol data units to said destination station device via said network based on said determination.

5. The system according to claim 4, wherein said one or more circuits enable selection of a time instant for said transmission when said received one or more filtering descriptions comprise one or more traffic shaping rules.

6. The system according to claim 5, wherein said one or more circuits enable processing of said received one or more protocol data units based on said one or more traffic shaping rules when a pattern match is detected between at least one of said one or more filtering patterns and at least one of said received one or more protocol data units.

7. The system according to claim 4, wherein said one or more circuits enable said transmission when a pattern match is detected between at least one of said one or more filtering patterns and at least one of said received one or more protocol data units.

8. The system according to claim 4, wherein said one or more circuits enable said transmission when a pattern match is not detected between at least one of said one or more filtering patterns and at least one of said received one or more protocol data units.

9. A system for communicating data, the system comprising:
one or more circuits that enable transmission of one or more filtering descriptions from a destination station device to an infrastructure networking device via a network; and
said one or more circuits enable reception of one or more protocol data units via said network that matches criteria corresponding to said transmitted one or more filtering descriptions.

10. The system according to claim 9, wherein said one or more circuits enable generation of said one or more filtering descriptions.

11. A method for communicating data, the method comprising:
receiving via a network, one or more filtering descriptions at an infrastructure networking device from a destination station device, wherein said infrastructure networking device enables said destination station device to communicate with said destination station and other station devices via said network;
receiving at said infrastructure networking device, one or more protocol data units destined for said destination station device; and
processing said received one or more protocol data units at said infrastructure networking device based on said one or more filtering descriptions.

12. The method according to claim 11, comprising generating one or more filtering patterns based on said one or more filtering descriptions.

13. The method according to claim 12, comprising determining whether to perform one of the following actions: transmit said processed said received one or more protocol data units, and discard said processed said received one or more protocol data units; based on said one or more filtering patterns.

14. The method according to claim 13, comprising transmitting said processed said received one or more protocol data units to said destination station device via said network based on said determining.

15. The method according to claim 14, comprising selecting a time instant for said transmission when said received one or more filtering descriptions comprise one or more traffic shaping rules.

16. The method according to claim 15, comprising processing said received one or more protocol data units based on said one or more traffic shaping rules when a pattern match is detected between at least one of said one or more filtering patterns and at least one of said received one or more protocol data units.

17. The method according to claim 14, comprising enabling said transmission when a pattern match is detected between at least one of said one or more filtering patterns and at least one of said received one or more protocol data units.

18. The method according to claim 14, comprising enabling said transmission when a pattern match is not detected between at least one of said one or more filtering patterns and at least one of said received one or more protocol data units.

19. A method for communicating data, the method comprising:
transmitting one or more filtering descriptions from a destination station device to an infrastructure networking device via a network; and
receiving one or more protocol data units via said network that matches criteria corresponding to said transmitted one or more filtering descriptions.

20. The method according to claim 19, comprising generating said one or more filtering descriptions.

21. A machine and/or computer readable medium, having stored thereon, a computer program having at least one code section executable by a machine and/or computer, thereby causing the machine and/or computer to perform steps for communicating data, the machine and/or computer readable medium comprising code for:
receiving via a network, one or more filtering descriptions at an infrastructure networking device from a destination station device, wherein said infrastructure networking device enables said destination station device to communicate with said destination station and other station devices via said network;
receiving at said infrastructure networking device, one or more protocol data units destined for said destination station device; and
processing said received one or more protocol data units at said infrastructure networking device based on said one or more filtering descriptions.

22. The machine and/or computer readable medium according to claim 21, comprising code for generating one or more filtering patterns based on said one or more filtering descriptions.

23. The machine and/or computer readable medium according to claim 22, comprising code for determining whether to perform one of the following actions: transmit said processed said received one or more protocol data units, and discard said processed said received one or more protocol data units; based on said one or more filtering patterns.

24. The machine and/or computer readable medium according to claim 23, comprising code for transmitting said processed said received one or more protocol data units to said destination station device via said network based on said determining.

25. The machine and/or computer readable medium according to claim 24, comprising code for selecting a time instant for said transmission when said received one or more filtering descriptions comprise one or more traffic shaping rules.

26. The machine and/or computer readable medium according to claim 25, comprising code for processing said received one or more protocol data units based on said one or more traffic shaping rules when a pattern match is detected between at least one of said one or more filtering patterns and at least one of said received one or more protocol data units.

27. The machine and/or computer readable medium according to claim 24, comprising code for enabling said transmission when a pattern match is detected between at least one of said one or more filtering patterns and at least one of said received one or more protocol data units.

28. The machine and/or computer readable medium according to claim 24, comprising code for enabling said transmission when a pattern match is not detected between at least one of said one or more filtering patterns and at least one of said received one or more protocol data units.

29. A machine and/or computer readable medium, having stored thereon, a computer program having at least one code section executable by a machine and/or computer, thereby causing the machine and/or computer to perform steps for communicating data, the machine and/or computer readable medium comprising code for:
transmitting one or more filtering descriptions from a destination station device to an infrastructure networking device via a network; and
receiving one or more protocol data units via said network that matches criteria corresponding to said transmitted one or more filtering descriptions.

30. The machine and/or computer readable medium according to claim 29, comprising code for generating said one or more filtering descriptions.
